(19) United States
(12) Patent Application Publication
(10) Pub. No.: US 2007/0266231 A1
(43) Pub. Date: Nov. 15, 2007

(54) Portable Electronic Device and Method for Loading Resource Data of the Portable Electronic Device

(76) Inventor: Huey-Tyug Chua, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/383,220

(22) Filed: May 15, 2006

(51) Int. Cl. G06F 15/177

(52) U.S. Cl. 713/1

(57) ABSTRACT

A method for loading resource data of a portable electronic device is disclosed. The method includes classifying the resource data into a first data set and a second data set; loading the first data set from a first storage device to a second storage device during a boot-up process; and loading the second data set from the first storage device to the second storage device after the first data set has been loaded to the second storage device.

### BACKGROUND

Personal portable electronic devices, like mobile phones, are very popular. However, it is very often annoying to the user of said device when said device requires an inextricably long time to boot-up. In order to boot-up, the device shall first load a boot-up program and resource data from a non-volatile memory to a volatile memory, and then execute the boot-up program together with access some of the resource data. As is well known, a mobile phone for example, shall access the data of selected wallpaper and language during the boot-up process.

The growing requirements demanded by the users of such devices for higher quality entertaining related features, like multiple languages, games, video playback and recording, and high-resolution cameras, have resulted in increased size of the resource data, exacerbating the slow loading time and increasing the boot-up time of these devices.

In summary, currently resource data is not loaded in an efficient way whereas to minimize boot-up time and latency noticed by the user. Therefore, it is apparent that new and improved methods and devices are needed.

### SUMMARY

A method for loading resource data of a portable electronic device is disclosed. The method comprises: classifying the resource data into a first data set and a second data set; loading a boot-up program and the first data set from a first storage device to a second storage device; executing the boot-up program for completing a boot-up process of the portable electronic device; and during the execution of the boot-up program, loading the second data set after the first data set has been loaded to the second storage device.

Another method for loading resource data of a portable electronic device is also disclosed. The method comprises: classifying the resource data into a first data set and a second data set; loading the first data set and a boot-up program from a first storage device to a second storage device; executing the boot-up program for completing a boot-up process of the portable electronic device; and loading the second data set from the first storage device to the second storage device after the execution of the boot-up program.

A portable electronic device for loading resource data is disclosed. The portable electronic device comprises: a first storage device, storing the resource data and a boot-up program; a second storage device; and a microprocessor, coupled to the first storage device and the second storage device, for executing the boot-up program for completing a boot-up process of the portable electronic device. The resource data is classified into a first data set and a second data set. The microprocessor performs the following operations: loading the first data set and the boot-up program from the first storage device to the second storage device; executing the boot-up program; and during the execution of the boot-up program, loading the second data set after the first data set has been loaded to the second storage device.

Another portable electronic device for loading resource data is also disclosed. The portable electronic device comprises: a first storage device, storing the resource data and a boot-up program; a second storage device; and a microprocessor, coupled to the first storage device and the second storage device, for executing the boot-up program to complete a boot-up process of the portable electronic device. The resource data is classified into a first data set and a second data set. The microprocessor performs the following operations: loading the first data set and the boot-up program from the first storage device to the second storage device; executing the boot-up program; and loading the second data set from the first storage device to the second storage device after the execution of the boot-up program.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an exemplary embodiment of a portable electronic device according to the present disclosure.

FIG. 2 is a flowchart of a method performed by the portable electronic device shown in FIG. 1 according to a first embodiment of the present invention.

FIG. 3 is a flowchart of a method performed by the portable electronic device shown in FIG. 1 according to a second embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

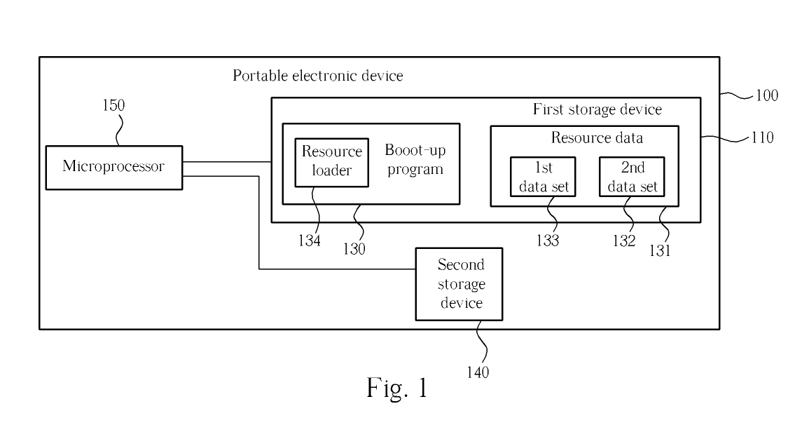

Please refer to FIG. 1. FIG. 1 is a block diagram of an embodiment of a portable electronic device 100 according to the present disclosure. The portable electronic device 100 comprises a first storage device 110, a second storage device 140, and a microprocessor 150. The first storage device 110 is used for storing the resource data 131 and a boot-up program 130. By way of example, and not limitation, the first storage device 110 can be a non-volatile storage device, such as a NAND-Flash memory or some other storage memory that offers an equivalent functionality (i.e., non-volatile storage). The resource data 131 is classified into a first data set 133 and a second data set 132 that will be described in detail later. Additionally, by way of example, and not limitation, the second storage device 140 can be a volatile storage device, such as a DRAM memory or some other storage memory that offers an equivalent functionality (i.e., fast response storage). The microprocessor 150, coupled to the first storage device 110 and the second storage device 140, is for performing the following operations. The microprocessor 150 first loads the first data set 133 and the boot-up program 130 into the second storage device 140, and then executes the boot-up program 130 for completing a boot-up process of the portable electronic device 100. Thereafter the boot-up program 130 generates a plurality of task threads according to the boot-up process of the portable electronic device 100. Threads include those responsible for processing air signals and network protocol layers, also threads in charge of handling peripherals and the user interface (UI). In a first embodiment of the present invention, the boot-up program 130 will initiate the resource loader 134 where the microprocessor 150 will execute the resource loader 134 to control the loading procedure of the second data set 132. There are many ways to achieve this task, for example, the resource loader 134 can be a code segment belonging to the boot-up program 130 as shown in FIG. 1. Alternatively, the boot-up program 130 can generate (i.e., spawn) the resource loader 134 as an independent thread/process, or finally, the resource loader 134 can exist as a code segment independent of the boot-up program 130 wherein the boot-up program 130 merely causes the resource loader 134 to begin execution via the microprocessor 150. These alternative designs all fall in the scope of the present invention. In this embodiment, the resource loader 134 is a code segment belonging to the boot-up program 130 and will be assigned the second lowest priority among all of the other threads for determining when the threads are given execution time on the microprocessor 150. Please note that an idle task is always assigned the lowest priority. In a second embodiment of the present invention, the resource loader 134 is optional and can be excluded from the boot-up program 130 since the loading of the second data set 132 is actuated after the boot-up process is completed.

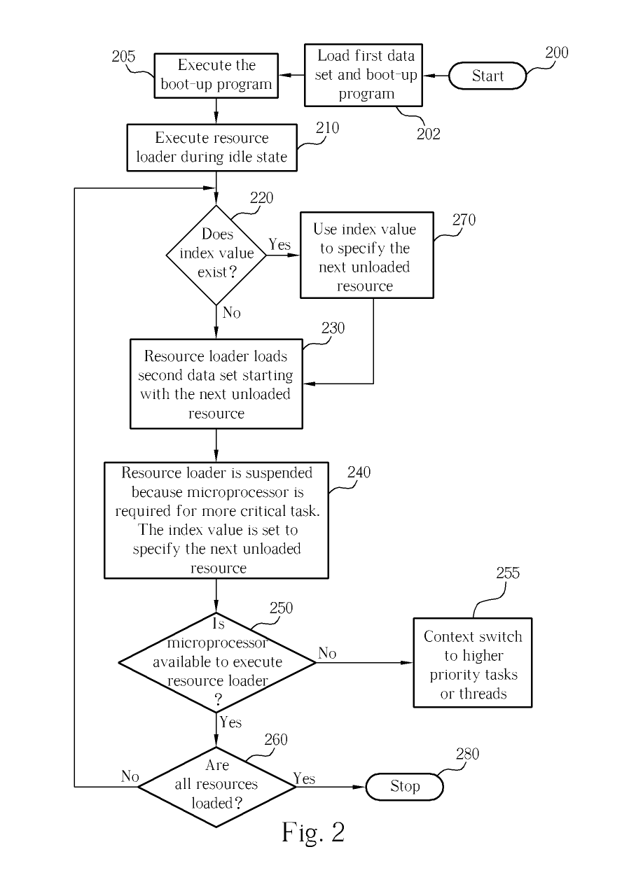

Additional details of the present disclosure of data classification follow. Specifically, the present invention classifies data that is utilized during the boot-up process of the portable electronic device 100 as belonging to the first data set 133 and classifies data that is not utilized during the boot-up process of the portable electronic device 100 as belonging to the second data set 132. As described later in reference to FIG. 2, the importance of the data classification will become apparent. Specifically, the first data set 133 will consist of data that is requested by some code segments of the boot-up program 130 whereas said code segments require said data for completing the boot-up process of the portable electronic device 100. It should be noted that the present invention classifies the resource data 131 into the first data set 133 and the second data set 132, and guarantees that the first data set 133 is loaded before the second data set 132 in either of the first and second embodiments of the present invention. Therefore, when the boot-up program 130 is executed to control the boot-up process, the first data set 133 is sure to be available to the execution of the boot-up program 130. In addition, the loading of the second data set 132 in either of the first and second embodiments of the present invention will not influence the boot-up process, which is detailed as below.

According to the first embodiment of the present disclosure, the portable electronic device 100 is a mobile phone. The operation of a mobile phone is well known to a person of average skill in the pertinent art; therefore, additional details specific to the general operations of the mobile phone are omitted for the sake of brevity. Details pertaining specifically to the present disclosure follow. In the first embodiment, the second data set 132 is loaded during the execution of the boot-up program 130. Resource data includes wall papers, background pictures, pictures, ring tones, music, and all of the other media-type resource data that a user wishes to store in their mobile phone. The first data set 133 contains resource data that is used during the boot-up process of the portable electronic device 100. In other words, the first data set 133 can also be referred to as foreground resource data. The second data set 132 contains resource data that is not used during the boot-up process of the portable electronic device 100. For example, the user will have selected a wallpaper design. Said currently selected wall paper design will be necessary during the boot-up process of the portable electronic device 100, however, the multitude of other wall papers are not necessary at this time. Additionally, the language that the user has currently selected for the portable electronic device 100 is a resource data that must be classified into the first data set 133 because it will be necessary for the boot-up process, however, the multitude of additional languages that are stored within the portable electronic device 100 are not needed during the boot-up process, therefore, these resource data are classified into the second data set 132. The resource loader 134 loads the second data set 132 during the execution of the boot-up program 130. It should be noted that since the resource loader 134 is a specific task assigned the second lowest priority higher than the idle task, the resource loader 134 operates only when the portable electronic device 100 is idle during the boot-up process. In the first embodiment, all of the resource data 131 (i.e., the first data set 133 and the second data set 132) is loaded during the boot-up process, where the second data set 132 is loaded during the portable electronic device 100 is idle. Therefore, loading the second data set 132 during the execution of the boot-up program 130 does not slow the normal boot-up process.

In other words, if the mobile phone is occupied with tasks that are more critical, the microprocessor 150 can interrupted the resource loader 134 of lower priority to allow other tasks to execute. For example, those critical tasks are tasks that will have negative impact on a successful boot-up process and those tasks that cause obviously response latency to the user interface thereby creating significant inconvenience for the user. This can be implemented using a system scheduler, threads, and a process priority scheme. It is obvious to one of average skill in this art that the present disclosure can easily accommodate the features of the present embodiment and that these features obey the spirit of the present disclosure. Therefore, additional details regarding the operation and implementation of priority thread scheduling in a real-time operating system such as would be found in a mobile phone as omitted for the sake of brevity.

There may be a situation where the boot-up process is finished, while the second data set is not completely loaded. In this case, it can be designed that the portable electronic device 100 will keep on loading the second data source after the boot-up process is finished. However, similarly, the loading of the second data set is a task having the second lowest priority higher than an idle task so as not to have any impact on the performance of functions of the device. Also, it can be designed that after the boot-up process is completed, the unloaded second data set is loaded on demand.

It also can be designed that the second data set is further divided into two sets separately assigned a higher and a lower priority that is a higher priority second data set and a lower priority second data set. Therefore, it can be designed that higher priority second data set is loaded during the execution of the boot-up process, while the lower priority second data set is loaded after the boot-up process is finished. Also, the loading of the lower priority second data set can be designed as a task having the second lowest priority higher than an idle task so as not to have any impact on the performance of functions of the device or can be designed to be performed on demand.

Similarly, in the situation where the boot-up process is finished, while the higher priority second data set is not completely loaded, it can be designed that the portable electronic device 100 will keep on loading the higher priority second data source after the boot-up process is finished. The loading of the higher priority second data set is a task having the third lowest priority higher than loading of the lower priority second data set (the second lowest priority) and an idle task (the lowest priority). Also, it can be designed that after the boot-up process is completed, the unloaded higher priority second data set is loaded on demand.

The second embodiment is similar to the first embodiment, however, in the second embodiment of the present disclosure, the second data set 132 is loaded on-demand in a typical way the portable electronic device 100 loads data after the execution of the boot-up program 130 in contrast to the first embodiment where the second data set 132 is loaded during the execution of the boot-up program 130. As mentioned above, the resource data is classified into the first data set 133 and the second data set 132. Therefore, it is easily realized that the second data set 132 contains information not needed by the execution of the boot-up program 130, so the second embodiment does not load all of the resource data 131 during the boot-up process to thereby avoid slow response caused by the loading procedure of the second data set 132.

In this embodiment, the resource data 131 must more frugally load only the resource data 131 is needed at the time it is required (i.e., on-demand) from the second data set 132 to the second storage device 140. Please note, when the user changes selections via a user interface element, such as a scroll list, then a particular resource as selected by the user, perhaps a new wall paper, suddenly becomes a first data set 133 resource data. Based on a specific user's specific selections many resource data can switch (i.e., float or be reclassified) between the two data sets.

In the second embodiment, rather than loading the second data set on demand, it also can be designed that the second data set is divided into several sets having different priorities, for example, a first priority second data set, a second priority second data set, and a third priority second data set. It is designed the second data set is loaded after the boot-up process is completed and when the device 100 is idle. That is, loading of the first priority second data set is a task having forth lowest priority, the loading of the second priority second data set is a task having third lowest priority, the loading of the third priority second data set is a task having second lowest priority, while an idle task has the lowest priority, so as not to impact the performance of functions of the device 100.

Please refer to FIG. 2 in conjunction with FIG. 1. FIG. 2 is a flowchart of a method performed by the portable electronic device 100 shown in FIG. 1 according to the first embodiment of the present invention. The method comprises the following steps according to the first embodiment:

Step 200: Start.

Step 202: Load the first data set 133 and the boot-up program 130.

Step 205: Execute the boot-up program 130.

Step 210: Execute the resource loader 134 when the portable electronic device 100 enters an idle state.

Step 220: Does an index value exist? If no, continue to step 230. If yes, continue to step 270.

Step 230: The resource loader 134 loads the second data set 132 starting with the next resource that has not yet been loaded.

Step 240: The resource loader 134 is suspended (i.e., stops executing) because the microprocessor 150 must suspend the resource loader 134 to execute a more critical task.

Step 250: Is the microprocessor 150 available to execute the resource loader 134? If yes, continue to step 260. If no, go to step 255.

Step 255: Context switch to other higher priority tasks or threads.

Step 260: Are all of the resources loaded? If no, return to step 220. If yes, then continue to step 280.

Step 270: Reference the index value to specify the next resource that requires loading. Proceed to step 230.

Step 280: Stop.

Following is a detailed description of the flow illustrated in FIG. 2. Please note that this represents a simplified flow with respect to the operation of the portable electronic device 100. For example, if the portable electronic device 100 is a mobile phone then those of average skill in the art are well aware of the details that have been omitted for the sake of brevity. Rather, the following description focuses on the features and objects of the present disclosure.

In step 200, the flow begins. It is at this point that the user has turned on the portable electronic device 100. Resource data that is utilized during the boot-up process of the portable electronic device 100 belongs to the first data set; and resource data that is not utilized during the boot-up process belongs to the second data set.

Next, in step 202, the first data set 133 and the boot-up program 130 stored in the first storage device 110 are first loaded into the second storage device 140, where the first data set 133 is needed by the execution of the boot-up program 130.

Next, in step 205, the microprocessor 150 executes the boot-up program 130 to control the boot-up process. In step 210, the microprocessor 150 executes a thread (or a task) created by the boot-up program 130, i.e., the resource loader 134, when the portable electronic device 100 enters an idle state. At this point the boot-up program 130 has already begun execution and as a result the resource loader 134 is generated a new task thread having the second lowest priority just above the lowest priority assigned to the idle task (i.e., when the personal electronic device 100 is in an idle state). Obviously, the personal electronic device 100 has a specific start-up sequence and many steps of said sequence are omitted from this description, as they are not necessary for understanding the present disclosure.

Next, in step 220, the resource loader 134 references an index value. The index value can be a simply storage location in memory, perhaps either the first storage device 110 or the second storage device 140 or any other similar means for storing an index value. If the index value exists then the resource loader 134, by way of step 270, utilizes the index value to establish which resource data will be loaded next. For example, the index value can be a memory location indicating where the next resource to be loaded is stored. If the index value does not exist, then the flow directly continues to step 230.

Next, in step 230, the resource loader 134 loads the second data set 132 starting with the next resource data that has not yet been loaded. For example, according to the aforementioned first embodiment of the present invention, the resource loader 134 is configured to load the second data set 133 after the first data set 132 has been loaded wherein these operations take place while the boot-up program 130 is still executing.

Next, in step 240, the resource loader 134 is suspended (i.e., stops executing) by the microprocessor 150 because the microprocessor 150 must execute a more critical task of higher priority. For example, the resource loader 134 can be loading wallpaper designs when the microprocessor 150 is called upon to execute a task for network search. The details of process scheduling within, for example, a mobile phone, are well known and are omitted here. At this point, an index value is set to indicate the memory location of the resource data that was being loaded at the time when the microprocessor 150 suspended (i.e., performed a context switch) the resource loader 134. It is in this way, via step 270, that the resource loader 134 knows from which resource data to being the loading process once again next time the resource loader 134 is able to execute on the microprocessor 150.

Next, in step 250, the interrupted resource loader 134 waits for execution time from the microprocessor 150. If the microprocessor 150 is available to execute the resource loader 134, then the resource loader 134 will enjoy the benefit of execution time and continue loading the unloaded resource data that are located within the second data set 132 according to the information recorded in the index value (steps 220 and 230). If the microprocessor 150 remains busy then the resource loader 134 must wait until the microprocessor 150 becomes available and in the meantime, context switch to other higher priority tasks. For example, in this step, the resource loader 134 is a process waiting in a queue of many processes each contending for resource time (i.e., to be executed by the microprocessor 150). The details of process queuing, queue theory, resource allocation in a real-time operating system, and deadlock are all very well know to those of average skill in his art and are therefore omitted for the sake of brevity.

Next, in step 260, according to the first embodiment of the present invention, if all of the resources of the second data set 132 are loaded then the resource data loading has completed and then the flow terminates (step 280).

It is obvious that many changes can be made to the above flow which obeying the spirit of the present disclosure. For example, the present disclosure benefits from being an execution program code (i.e., the resource loader 134). Thereby it is easily integrated into any portable electronic device 100 that utilizes any sort of real-time operating system with an event scheduler. However, the present disclosure provides as much utility in any other device wherein resource data 131 loading must take place during boot-up process. The present disclose is still able to provide some utility even when it is implemented in a very simple device in which the benefit of process queuing is not available. In other words, the present disclosure still loads resource data whereby slow response of any portable electronic device is reduced.

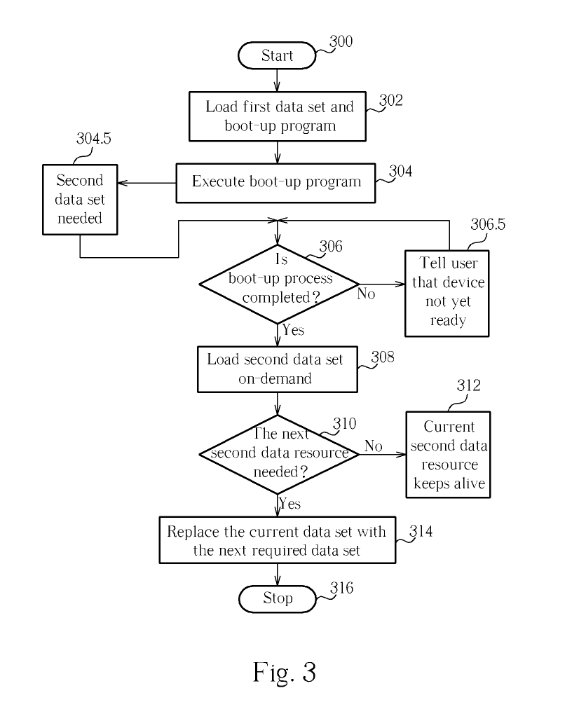

Please refer to FIG. 3 in conjunction with FIG. 1. FIG. 3 is a flowchart of a method performed by the portable electronic device 100 shown in FIG. 1 according to the second embodiment of the present invention. The method comprises the following steps according to the second embodiment:

Step 300: Start.

Step 302: Load the first data set 133 and the boot-up program 130.

Step 304: Execute the boot-up program 130.

Step 304.5: One of second data set 308 is toggled.

Step 306: Check if the boot-up process is completed by the execution of the boot-up program 130. If yes, go to step 308; otherwise, go back to step 306 to keep checking.

Step 306.5: The requirement cannot be proceeded due to second data set 308 could not be retrieved from non-volatile storage device.

Step 308: Load the second data set 308 on-demand.

Step 310: Is the next set of resource data needed? If yes, go to step 314; otherwise, go to step 312.

Step 312: The current second data set keeps alive.

Step 314: Replace the current data set with the next required data set.

Step 316: Stop.

The flow shown in FIG. 3 is similar to that shown in FIG. 2. The major difference is that the flow shown in FIG. 3 loads the second data set 308 after the boot-up program 130 has stopped executing (i.e., after the boot-up process of the portable electronic device 100 is completed) and does not need the execution of the resource loader 134 (steps 300-308). In addition, the second data set 308 is loaded on-demand, and then buffered in the second storage device 140. Please note, in the second embodiment the second data set 132 is loaded on-demand in a typical way the portable electronic device 100 loads data after the execution of the boot-up program 130 or at the same time as the execution of the boot-up program 130. For example, only one of a group of wall papers is loaded together with boot-up code in the idle state. User B requesting for browsing the wall papers, the current task is responsible to load the wall paper from non-volatile memory device. Having selected certain, new wall paper, the wall papers set still remain at volatile memory until the next request is toggled.

Further details about FIG. 3 follow. In step 304.5 the second data set 132 is needed and then in step 306 the boot-up process is checked for completion. If the boot-up process is completed then continue to step 308 to load the second data set 132 on-demand. If the boot-up process is not completed then in step 306.5 the user of the portable electronic device 100 is notified that the device is not yet ready and the flow returns to step 306. In step 310, if another second data set 132 resource is needed then in step 314 the current data set is replaced with the next required data set or, if no additional resources are needed from the second data set 132 then in step 312 the second data set 132 is kept alive.

In summary, the present disclosure provides a method and device for classifying the resource data 131 into a first data set 133 and a second data set 132 and then at least loading the first data set 133 during a boot-up process of the portable electronic device 100 whereby slow response of a portable electronic device 100 (e.g., a mobile phone) is reduced. This is achieved by focusing on resource data rather than firmware segments. As mobile phone handsets continue to contain greater storage capacity, the importance of the approach of the present disclosure is apparent.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for loading resource data of a portable electronic device, the method comprising:
classifying the resource data into a first data set and a second data set;
loading the first data set from a first storage device to a second storage device during a boot-up process of the portable electronic device; and
loading the second data set from the first storage device to the second storage device after the first data set has been loaded to the second storage device.

2. The method of claim 1, wherein the first data set comprises data required for completing the boot-up process of the portable electronic device.

3. The method of claim 1, wherein the second data set comprises data not needed for completing the boot-up process of the portable electronic device.

4. The method of claim 1, wherein the step of loading the second data set from the first storage device to the second storage device comprises:
loading the second data set from the first storage device to the second storage device after the boot-up process.

5. The method of claim 4, wherein the second data set is loaded on-demand.

6. The method of claim 4, wherein the first data set comprises data required for completing the boot-up process of the portable electronic device.

7. The method of claim 4, wherein the second data set comprises data not needed for completing the boot-up process of the portable electronic device.

8. The method of claim 1, wherein the step of loading the second data set comprises:
checking an index value and if the index value exists then setting a data to be a current data selected from the second data set according to the index value; and
loading the current data and all subsequent remaining data until the second data set is loaded into the second storage device.

9. The method of claim 1, wherein the portable electronic device data is compressed or encrypted.

10. The method of claim 1, wherein the portable electronic device is a mobile phone.

11. The method of claim 1, wherein the step of loading the second data set from the first storage device to the second storage device comprises:
loading the second data set from the first storage device to the second storage device during the boot-up process.

12. The method of claim 11, wherein the first data set comprises data required for completing the boot-up process of the portable electronic device.

13. The method of claim 11, wherein the second data set comprises data not needed for completing the boot-up process of the portable electronic device.

14. The method of claim 11, wherein the step of loading the second data set from the first storage device to the second storage device further comprises:
creating a specific task assigned the second lowest priority higher than an idle task; and
executing the specific task to load the second data set from the first storage device to the second storage device.

15. A portable electronic device for loading resource data, the portable electronic device comprising:
a first storage device, comprising the resource data and a boot-up program, wherein the resource data is classified into a first data set and a second data set;
a second storage device; and
a microprocessor, coupled to the first storage device and coupled to the second storage device, for loading the boot-up program and the first data set of the resource data from the first storage device to the second storage device during a boot-up process of the portable electronic device; for executing the boot-up program to complete the boot-up process; and for loading the second data set from the first storage device to the second storage device after the first data set has been loaded to the second storage device.

16. The portable electronic device of claim 15, wherein the first data set comprises data required for completing the boot-up process of the portable electronic device.

17. The portable electronic device of claim 15, wherein the second data set comprises data not needed for completing the boot-up process of the portable electronic device.

18. The portable electronic device of claim 15, wherein the microprocessor loads the second data set from the first storage device to the second storage device after the execution of the boot-up program.

19. The portable electronic device of claim 18, wherein the second data set is loaded on-demand.

20. The portable electronic device of claim 18, wherein the first data set comprises data required for completing the boot-up process of the portable electronic device.

21. The portable electronic device of claim 18, wherein the second data set comprises data not needed for completing the boot-up process of the portable electronic device.

22. The portable electronic device of claim 15, wherein the microprocessor further checks an index value, wherein if the index value exists then the microprocessor sets a data to be a current data selected from the second data set according to the index value and loads the current data and all subsequent remaining data until the second data set is loaded into the second storage device.

23. The portable electronic device of claim 15, wherein the portable electronic device data is compressed or encrypted.

24. The portable electronic device of claim 15, being a mobile phone.

25. The portable electronic device of claim 15, wherein the microprocessor loads the second data set from the first storage device to the second storage device during the execution of the boot-up program.

26. The portable electronic device of claim 25, wherein the first data set comprises data required for completing the boot-up process of the portable electronic device.

27. The portable electronic device of claim 25, wherein the second data set comprises data not needed for completing the boot-up process of the portable electronic device.

28. The portable electronic device of claim 25, wherein the microprocessor creates a specific task assigned the second lowest priority higher than an idle task, and executes the specific task to load the second data set from the first storage device to the second storage device.
